(19) United States
(12) Patent Application Publication
(10) Pub. No.: US 2012/0073533 A1
(43) Pub. Date: Mar. 29, 2012

(54) CAMSHAFT DEVICE, ENGINE WITH SAME, AND METHOD FOR MANUFACTURING CAMSHAFT DEVICE

(75) Inventors: Kazuki Hamada, Kashiwara-shi (JP); Hiroshi Ueno, Tondabayashi-shi (JP); Isao Usuki, Yamatotakada-shi (JP); Kunio Yanai, Katsuragi-shi (JP); Hironori Hiraoka, Yao-shi (JP); Kotaro Yamashita, Kashiwara-shi (JP); Hiroshi Satou, Hamura-shi (JP); Takaaki Ikeda, Nara-shi (JP); Ryo Oonishi, Kashiba-shi (JP)

(73) Assignee: JTEKT CORPORATION, Osaka-shi, Osaka (JP)

(21) Appl. No.: 13/322,493

(22) PCT Filed: May 19, 2010
(86) PCT No.: PCT/JP2010/058439

§ 371 Date: Nov. 25, 2011

(30) Foreign Application Priority Data
Jun. 18, 2009 (JP) 2009-145416

(51) Int. Cl. F01L 1/02; F16H 53/00; B21D 53/84

(52) U.S. Cl. 123/90.27; 29/888.1; 74/567

(57) ABSTRACT

A camshaft device (10) includes a camshaft (11) onto which a cam (18) is fitted; a plurality of rolling bearings (12) that are fitted at intervals in an axial direction onto this camshaft (11); and a support frame (13) that is mounted on a cylinder head (15) of an engine, and that has a plurality of bearing holes (25) which are formed on the same axis and into which the rolling bearings (12) fitted, and that rotatably supports the camshaft (11) via the rolling bearings (12) that are fitted into the bearing holes (25). The support frame (13) is formed by connecting a plurality of split bodies (27), (28) together, and the plurality of split bodies (27), (28) includes a first split body (27) on which a plurality of first concave portions (29) that form half of the bearing holes (25) is integrally formed, and a second split body (28) on which a plurality of second concave portions (30) that form the other half of the bearing holes (25) is integrally formed.

### TECHNICAL FIELD

The present invention relates to a camshaft device mounted on a cylinder head of an engine, an engine provided with the same, and a method for manufacturing a camshaft device.

### BACKGROUND ART

A camshaft for operating intake and exhaust valves open and closed is provided in an engine used in an automobile or the like. For example, in a DOHC engine, a camshaft is rotatably supported via a plurality of bearings mounted onto an upper portion inside the engine.

Also, as the bearings that support the camshaft, plain bearings (see Patent Document 1, for example) or rolling bearings such as deep groove ball bearings or needle bearings or the like (see Patent Document 2, for example) are conventionally used.

### Prior Art Documents

### Patent Documents

Patent Document 1: Japanese Patent Application Publication No. 2000-282811

Patent Document 2: Japanese Patent Application Publication No. 2006-226183

### OUTLINE OF THE INVENTION

### Problem to be Solved by the Invention

The bearings that support the camshaft are fitted in bearing holes formed inside the engine. These bearing holes have a split structure including a semicircular concave portion that opens upward and is formed in an upper portion of the cylinder head, and a semicircular concave portion that opens downward and is formed in a cap member that is bolt-fixed to the cylinder head.

Also, a plurality of bearing holes is formed by aligning the semicircular concave portions of a plurality of cap members with the plurality of semicircular concave portions formed in the cylinder head, and bolt-fixing each cap member to the cylinder head.

However, each of the plurality of cap members is fitted to the cylinder head individually, so there are drawbacks such as variation in roundness among the plurality of bearing holes, and a decrease in the coaxiality. These kinds of drawbacks are unable to be solved even if all of the cap members are fitted to the cylinder head and all of the bearing holes are integrally formed, when forming the bearing holes in the cylinder head and cap members.

When a plain bearing is used as a bearing that supports the camshaft, a slight clearance is formed between the outer peripheral surface of the plain bearing and the inner peripheral surface of the bearing hole. Therefore, even if there is variation in the roundness among the plurality of bearing holes or the coaxiality decreases, it is possible to rotate the plain bearing inside the bearing hole, but it takes a long time for the plain bearing to be adapted to rotate smoothly. Also, typically, the plain bearing slides in constant contact with the inside of the bearing hole, so compared with a rolling bearing, the running torque is large and noise is also easily produced, which are also drawbacks.

In contrast, a rolling bearing has less running resistance than a plain bearing, so it is considered that the running torque can easily be reduced by using it as a bearing that supports the camshaft. However, in actuality, rolling bearings are fastened tightly by the inner peripheral surface of the bearing holes, so if misalignment among rolling bearings becomes large due to low coaxiality among the plurality of bearing holes, the internal clearance of the rolling bearings is unable to be appropriately maintained, which may result in an increase in the running torque.

In view of the foregoing circumstances, one object of the present invention is to provide a camshaft device capable of reducing running torque of a rolling bearing that rotatably supports a camshaft, an engine provided with the same, and a method for manufacturing a camshaft device.

### Means for Solving the Problem

A camshaft device according to one aspect of the present invention includes a camshaft onto which a cam is fitted; a plurality of rolling bearings fitted onto this camshaft at intervals in an axial direction; and a support frame that is mounted on a cylinder head of an engine, and that has a plurality of bearing holes which are formed on the same axis and into which the rolling bearings are fitted, and that rotatably supports the camshaft via the rolling bearings that are fitted into the bearing holes. The support frame is formed by connecting a plurality of split bodies, and the plurality of split bodies includes a first split body on which a plurality of first concave portions that form half of the bearing holes is integrally formed, and a second split body on which a plurality of second concave portions that form the other half of the bearing holes is integrally formed.

An engine according to one aspect of the present invention is formed by connecting the camshaft device described above to an upper surface portion of a cylinder case.

A method according to one aspect of the present invention for manufacturing the camshaft device described above includes a step of temporarily fitting together the positioned first split body and second split body on which the first and second concave portions, respectively, have not been formed; a step of forming the plurality of bearing holes, on the same axis, in the temporarily fitted first split body and second split body; and a step of, after separating the first and second split bodies, repositioning and connecting the first and second split bodies while fitting the rolling bearings that are fitted on the camshaft into the first and second concave portions formed in the first and second split bodies, respectively.

### Effects of the Invention

According to the present invention, running torque and vibration of the camshaft can be reduced.

### BRIEF DESCRIPTION OF THE DRAWINGS

FIG. 1 is a perspective view of a camshaft device according to a first example embodiment of the present invention.

FIG. 2 is an exploded perspective view of the camshaft device and a cylinder head.

FIG. 3 is a plain view showing a support frame of the camshaft device.

FIG. 4 is an arrow view taken along line IV-IV in FIG. 3.

FIG. 5 is a sectional view taken along line V-V in FIG. 3.

FIG. 6 is a plain view showing a support frame of a camshaft device according to a second example embodiment of the present invention.

FIG. 7 is an arrow sectional view taken along line VII-VII in FIG. 6.

FIG. 8 is a perspective view of a camshaft device according to a third example embodiment of the present invention.

FIG. 9 is a perspective view of a camshaft device according to a fourth example embodiment of the present invention.

FIG. 10 is an exploded perspective view of a cylinder head and a camshaft device according to a fifth example embodiment of the present invention.

FIG. 11 is a partial plain view of the camshaft device in FIG. 10.

FIG. 12 is an exploded perspective view of a cylinder head and a camshaft device according to a sixth example embodiment of the present invention.

FIG. 13 is an exploded perspective view of a cylinder head and a camshaft device according to a seventh example embodiment of the present invention.

FIG. 14 is an exploded perspective view of a cylinder head and a camshaft device according to an eighth example embodiment of the present invention.

### MODES FOR CARRYING OUT THE INVENTION

Hereinafter, example embodiments of the present invention will be described with reference to the drawings.

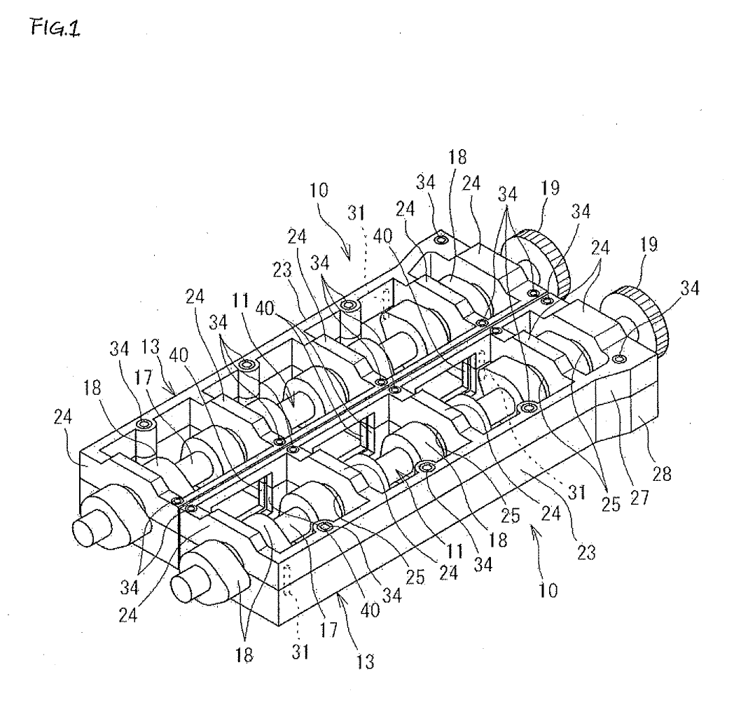

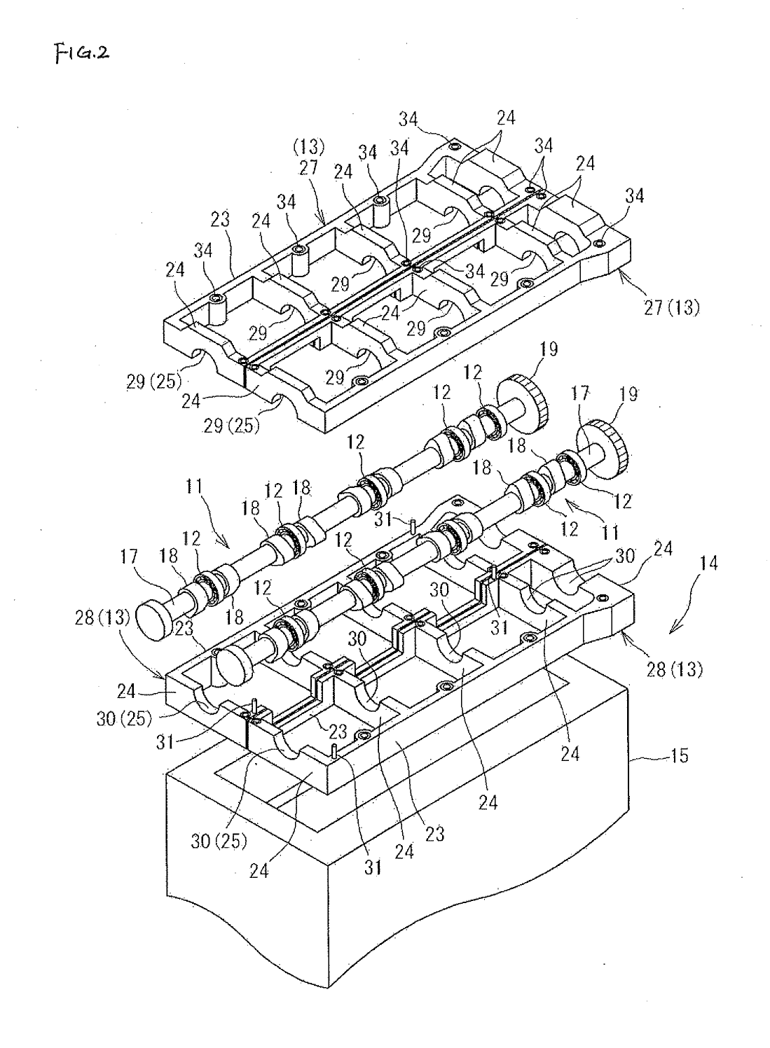

FIG. 1 is a perspective view showing a camshaft device of the present invention, and FIG. 2 is an exploded perspective view of the camshaft device.

A camshaft device 10 includes a camshaft 11, and a support frame 13 that rotatably supports this camshaft 11 via rolling bearings 12. In the example in FIG. 1 and FIG. 2, two camshaft devices 10 are arranged lined up, and each is mounted onto a cylinder head 15 of a DOHC 4 cycle engine 14.

As shown in FIG. 2, the camshaft 11 of each camshaft device 10 includes a shaft main body 17, and a plurality of cams 18 provided on the shaft main body 17 at intervals in the axial direction. The cams 18 of this example embodiment are provided in four sets in the axial direction, with two per set.

A toothed pulley 19 is fitted at one axial end of the camshaft 11, and power from a crankshaft, not shown, is transmitted via a timing belt to this toothed pulley 19.

Also, a plurality of rolling bearings 12 is fitted onto the shaft main body 17. More specifically, the rolling bearings 12 are provided in a total of five locations, respectively, between the two cams 18 of each set, and at an end portion of the shaft main body 17 on the toothed pulley 19-side. These rolling bearings 12 are deep groove ball bearings or needle bearings or the like, and have annular inner and outer rings and rolling elements.

Also, an annular single-piece member, not a split (two-piece) member, is used for each of the inner ring and outer ring of this example embodiment. Using a single-piece member as each of the inner and outer ring in this way makes it possible to prevent vibration and noise from being generated due to the rolling element passing over the split surface, as is the case with a split inner and outer ring.

The cams 18 described above are formed as separate parts, instead of being integrally formed with the shaft main body 17, and are mounted by being fitted onto the outer peripheral surface of the shaft main body 17. Using such cams 18 also enables the rolling bearings 12 that have inner and outer rings, each of which is a single-piece member, to be fitted onto the shaft main body 17 together with the cams 18.

The inner rings of the rolling bearings 12 may be omitted, and the shaft main body 17 itself may be used as the inner ring. Also, the rolling bearing 12 may be fitted between the cams 18 in each set.

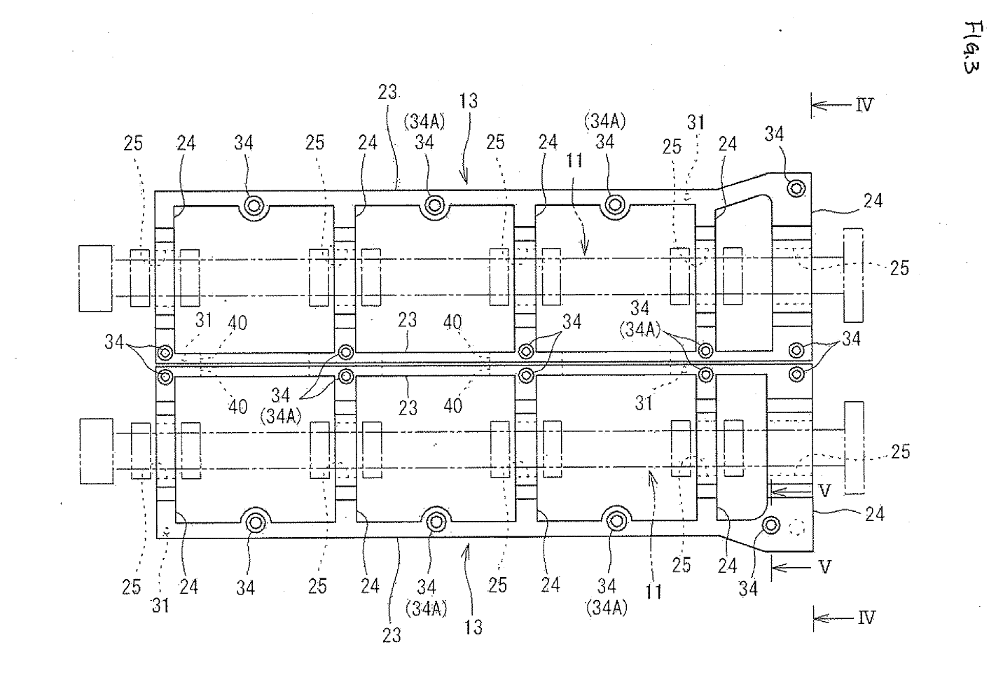

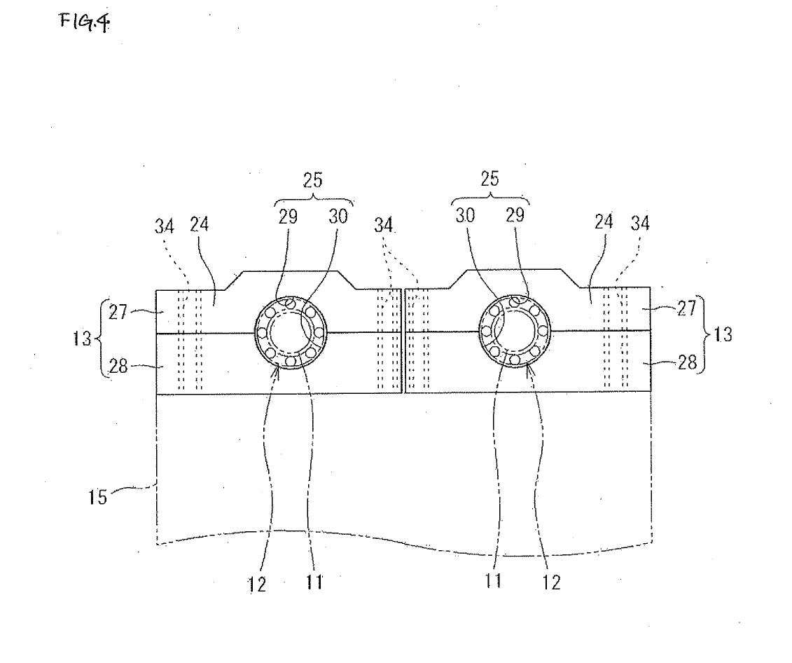

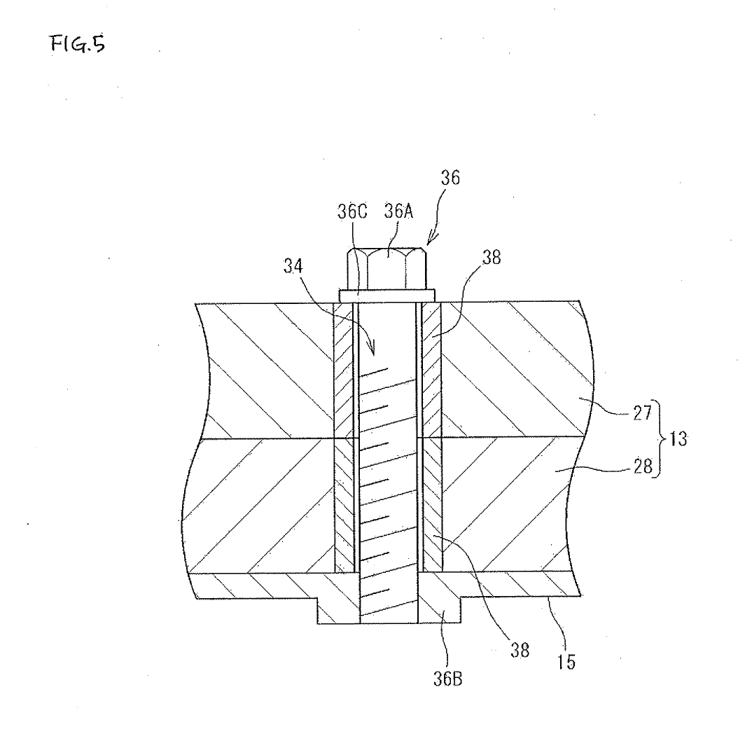

FIG. 3 is a plain view showing the support frame 13 of the camshaft device 10, FIG. 4 is an arrow view taken along line IV-IV in FIG. 3, and FIG. 5 is a perspective view taken along line V-V in FIG. 3. The support frame 13 is made of aluminum alloy or cast iron. Also, the support frame 13 includes a pair of side wall portions 23 arranged along the axis of the camshaft 11, and a plurality of support wall portions 24 is extended between the pair of side wall portions 23, and is formed in a ladder structure when viewed from above.

A plurality of bearing holes 25 into which the rolling bearings 12 are fitted is formed on the same axis in the support wall portion 24. In this example embodiment, five support wall portions 24 (bearing holes 25), that is the same number as there are rolling bearings 12, are provided.

Also, the support frame 13 has a two-tiered split structure. More specifically, as shown in FIG. 2, the support frame 13 is formed by connecting a first split body 27 located on the upper side with a second split body 28 located on the lower side.

The side wall portions 23 and support wall portions 24 of the support frame 13 are each split into an upper portion and a lower portion, and the bearing holes 25 formed in the support wall portions 24 are also each split into an upper portion and a lower portion. Therefore, the bearing holes 25 are formed of semicircular concave portions (first concave portions) 29 that open downward and are formed on the first split body 27 located on the upper side, and semicircular concave portions (second concave portions) 30 that open upward and are formed on the second split body 28 located on the lower side, as shown in FIG. 4.

The first split body 27 and the second split body 28 are positioned with respect to one another by positioning pins 31 (see FIG. 1 and FIG. 2) provided in appropriate locations, such that the first concave portions 29 and the second concave portions 30 are able to be aligned appropriately. The positioning pins 31 are formed protruding on the mating surface of one of the first and second split bodies 27 and 28, and are inserted into positioning holes (not shown) formed in the mating surface of the other of the first and second split bodies 27 and 28. Therefore, the positioning pins 31 and the positioning holes form positioning means for positioning the first and second split bodies 27 and 28.

As shown in FIG. 3, bolt inserting holes 34 are formed near intersecting portions between one side wall portion 23 and the support wall portions 24. Also, in the other side wall portion 23, bolt inserting holes 34 are also formed in positions halfway between the support wall portions 24 that are consecutive in the axial direction. In the support wall portion 24 arranged at an end portion (right end portion) on one side in the axial direction, a bolt inserting hole 34 is also formed near an intersecting portion with the other side wall portion 23.

Also, the first split body 27 and the second split body 28 are connected to each other by a connecting fitting (connecting means) 36 formed by a bolt 36A inserted into each bolt inserting hole 34, and a nut member 36B having a female screw thread with which this bolt 36A screws together, as shown in FIG. 5.

In this example embodiment, the bolts 36A that are inserted into the bolt inserting holes 34 are screwed together with the female screw threads formed in the cylinder head 15, and the first and second split bodies 27, 28 are both fastened and fixed to the cylinder head 15. Therefore, the nut member 36B is formed by the cylinder head 15 itself.

The connecting fitting 36 may also be structured such that fastening is achieved by a pin such as a press-fit pin or a ratchet pin.

A tubular body 38 made of a more rigid material than the support frame 13, for example, steel or the like when the support frame 13 is made of a light alloy such as aluminum alloy or magnesium alloy, is fixed by press-fitting inside each bolt inserting hole 34. This tubular body 38 is formed with a larger diameter than a head of the bolt 36A and a washer 36C, at a length that extends the entire length of the bolt inserting hole 34, and is configured to be able to receive fastening power from the connecting fitting 36.

Therefore, even if the connecting fitting 36 is fastened tightly to tightly connect the first and second split bodies 27, 28 together, that fastening power is not easily transmitted directly from the head of the bolt 36A to the support frame 13, so distortion can be prevented from occurring in the support frame 13. Therefore, this kind of distortion has almost no adverse effect on the roundness and coaxiality of the bearing holes 25.

The tubular body 38 may also be fixed to the support frame 13 by being cast together when the support frame 13 is formed.

As shown in FIG. 1, in each of the support frames 13 of the two camshaft devices 10, open portions 40 are formed so as to lie astride both the first and second split bodies 27, 28 in the side wall portions 23 that are arranged on the inner side of the engine 14. These open portions 40 make the support frames 13 lighter.

In each support frame 13, the same kind of open portions 40 may also be formed also in the side wall portions 23 on the engine outer side. However, because there is a possibility that oil inside the engine may leak from the open portions 40, it is more preferable to form the open portions 40 only in the side wall portions 23 located on the engine inner side, as in this example embodiment. However, if a cover that covers the outside of the support frame 13 is provided separately, the open portions 40 may also be formed in the side wall portions 23 located on the engine outer side with no trouble.

The first and second split bodies 27, 28 of the support frame 13 are formed by aluminum die-casting or low-pressure casting or the like. Also, the bearing holes 25 are formed in the formed first and second split bodies 27, 28 after the mating surfaces have been formed and the positioning pins 31 have been installed and the like.

To form the bearing holes 25 in the support frame 13, first of all, the first and second split bodies 27, 28 are temporarily fitted together by being stacked on top of another while being positioned by the positioning pins 31, and then fixed by a clamp or a connecting fitting or the like. Also, pilot holes are formed so as to pass through the plurality of support wall portions 24 of the temporarily fitted first and second split bodies 27, 28, and then performing reaming or the like to form the bearing holes 25 of a prescribed tolerance.

In the camshaft device 10 described above, a plurality of first concave portions 29 is integrally formed on the first split body 27 of the support frame 13, and a plurality of second concave portion 30 is integrally formed on the second split body 28. Therefore, in each of the split bodies 27, 28, the relative positions between the plurality of concave portions 29 and the corresponding plurality of concave portions 30 are constant, so misalignment of the axial center among the plurality of concave portions 29, 30 will not occur. Also, the plurality of bearing holes 25 can be simultaneously formed by connecting the first and second split bodies 27, 28 together while aligning the plurality. of the first concave portions 29 and the second concave portions 30 with each other. Therefore, the coaxiality of the bearing holes 25 can be increased, misalignment among the plurality of rolling bearings 12 fitted into the bearing holes 25 can be reduced, and the running torque of the rolling bearings 12 can be reduced, compared with the case where the plurality of cap members are individually fitted to the cylinder head 15 and the plurality of bearing holes 25 are formed individually as in the related art.

Also, the plurality of bearing holes 25 in the support frame 13 is formed simultaneously with the first and second split bodies 27, 28 temporarily fitted together, so the coaxiality can be further increased and the variation in roundness can also be reduced.

Also, as shown in FIG. 3, for each of the bearing holes 25 other than the bearing holes 25 on the right end, one of the bolt inserting holes 34 into which the connecting fittings 36 are fitted is positioned on the radially outer side of the bearing hole 25 and coincides in axial position with this bearing hole 25, and the other bolt inserting hole 34 is positioned on the radially outer side of the bearing hole 25 and is offset in the axial direction from the bearing hole 25. When the bolt inserting holes 34 are arranged in positions offset in the axial direction from the bearing holes 25, even if the connecting fittings 36 are fastened tightly using the bolt inserting holes 34, that fastening power is lessened slightly by deflection of the support frames 13 by the time the fastening power reaches the bearing holes 25. Therefore, the outer rings of the rolling bearings 12 will almost never be fastened excessively by the inner peripheral surface of the bearing holes 25, and an increase in the running torque due to a decrease in the internal clearance of the rolling bearings 12 does not occur.

As a modified example of this example embodiment, among the plurality of the bolt inserting holes 34, some may be used only to connect the first split body 27 with the second split body 28, and the others may be used to connect the first and second split bodies 27, 28 with the cylinder head 15.

For example, as shown in FIG. 3, in each support frame 13, four of the bolt inserting holes 34 (denoted by reference character 34A in particular) may be used exclusively for connecting the first split body 27 with the second split body 28, and the other five bolt inserting holes 34 may be used for tightening the first and second split bodies 27, 28 and the cylinder head 15 together.

When structured in this way, the camshaft device 10 formed of the support frame 13 and the camshaft 11 can be assembled independently by connecting the first and second split bodies 27, 28 together by the connecting fittings 36 using the bolt inserting holes 34A, with the camshaft 11 set between the first and second split bodies 27, 28. Also, in this camshaft device 10 that has been assembled independently, the connection (such as the fastening of the connecting fittings 36) of the first and second split bodies 27, 28 can be adjusted such that the camshaft 11 rotates smoothly, and this camshaft device 10 can be mounted on the cylinder head 15 by the connecting fittings 36 using the remaining bolt inserting holes 34.

In this modified example, the fastening power of the connecting fittings 36 fitted in the bolt inserting holes 34 for fastening the first and second split bodies 27, 28 and the cylinder head 15 together should not affect the bearing holes 25 of the first and second split bodies 27, 28 of which the connection has already been adjusted. Therefore, all of the bolt inserting holes 34 for fastening the above members together are preferably formed in positions offset in the axial direction from the bearing holes 25, for example, in positions midway between the support wall portions 24 consecutive in the axial direction, in the side wall portions 23.

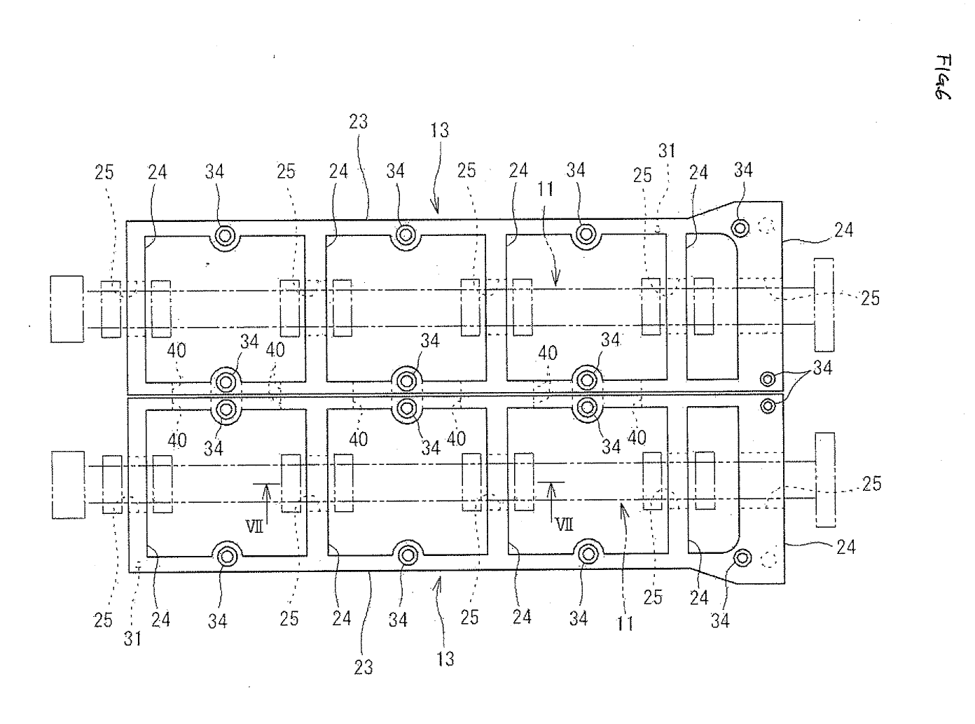

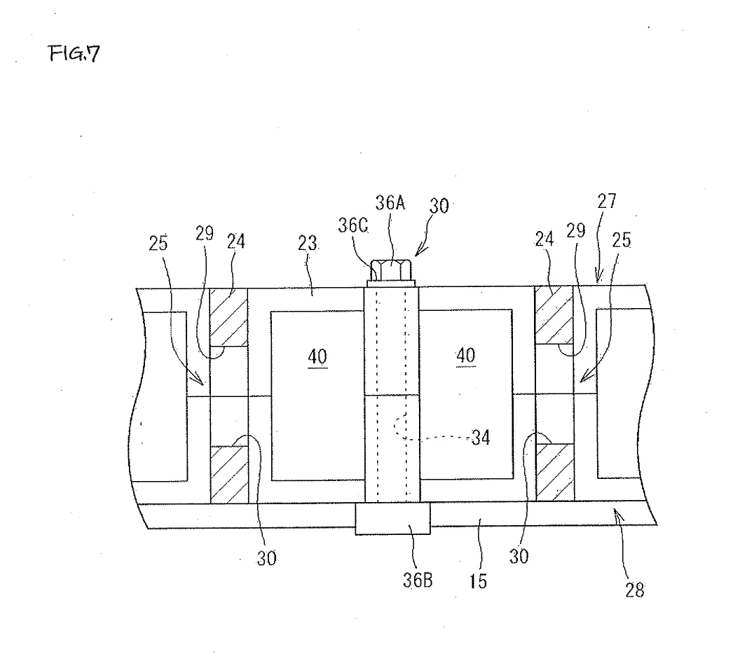

FIG. 6 is a plain view showing a support frame 13 of a camshaft device 10 according to a second example embodiment of the present invention, and FIG. 7 is an arrow sectional view taken along line VII-VII in FIG. 6. In this example embodiment, the other bolt inserting holes 34 than the bolt inserting holes 34 formed in the support wall portion 24 at the right end of the support frame 13 are formed in positions midway between the support wall portions 24 consecutive in the axial direction, in each of the pair of side wall portions 23. Therefore, the other bolt inserting holes 34 are arranged in positions away in the axial direction from the bearing holes 25, so even if the connecting fittings 36 are fastened tightly using the other bolt inserting holes 34, that fastening power will be lessened by the deflection of the support frame 13 by the time the fastening power reaches the bearing holes 25, and then transmitted to the bearing holes 25.

Moreover, as shown in FIG. 7, open portions (material removed portions) 40 are formed on both sides of the portions where the bolt inserting holes 34 are formed in one of the side wall portions 23, such that the rigidity of the side wall portions 23 at portions between the bolt inserting holes 34 and the support wall portions 24 is reduced in particular. Therefore, even if the connecting fittings 36 are fastened tightly using the bolt inserting holes 34, that fastening power will be easily be lessened further by the deflection of the support frame 13 by the time the fastening power reaches the bearing holes 25. Therefore, it is possible to more reliably suppress an increase in running torque due to a decrease in the internal clearance of the rolling bearings 12, because the outer rings of the rolling bearings 12 are not fastened excessively by the inner peripheral surface of the bearing holes 25. Also, it becomes possible to allow slight movement of the rolling bearings 12 using the deflection of the side wall portions 23, such that misalignment among the plurality of rolling bearings 12 can be absorbed and running torque can be decreased. The material removed portions 40 formed in one of the side wall portions 23 may be concave portions that do not pass through the side wall portions 23, instead of open portions that pass through the side wall portions 23.

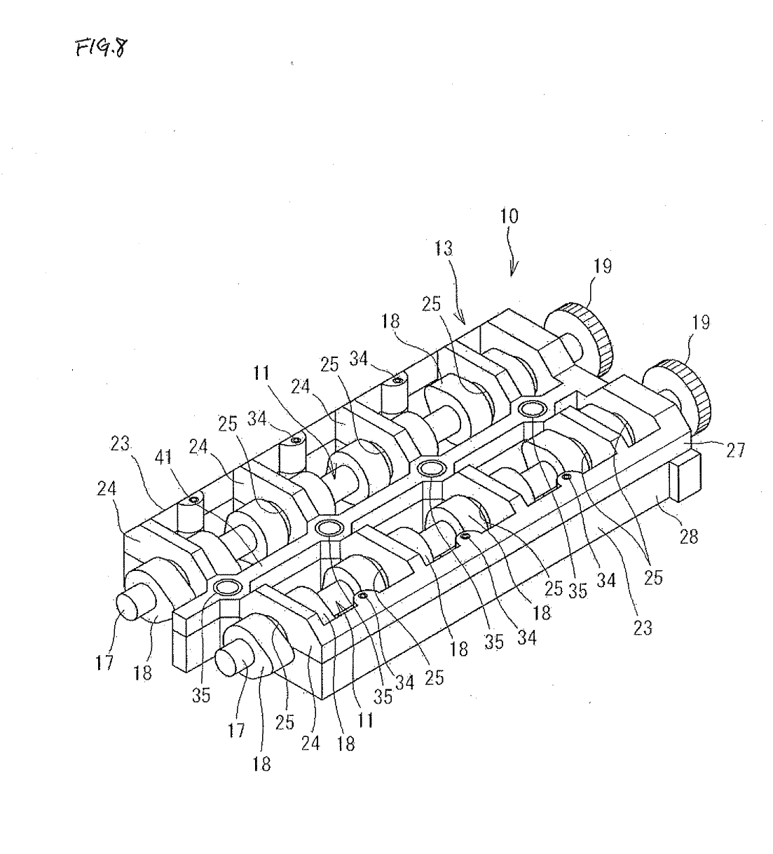

FIG. 8 is a perspective view of a camshaft device 10 according to a third example embodiment of the present invention. The camshaft device 10 according to this example embodiment corresponds to a member in which the two support frames 13 in the first example embodiment are substantially integrated with each other, and that rotatably supports the two camshaft shafts 11 using a single support frame 13. More specifically, the support frame 13 has a pair of side wall portions 23, an intermediate wall portion 41 arranged midway between both side wall portions 23, and a plurality of support wall portions 24 that are extended between one side wall portion 23 and the intermediate wall portion 41, and between the other side wall portion 23 and the intermediate wall portion 41. Also, bolt inserting holes 35 into which larger diameter bolts (connecting fittings) can be inserted are formed at intersecting portions between the intermediate wall portion 41 and the support wall portions 24. Therefore, in this example embodiment, as in the first example embodiment, the first and second split bodies 27, 28 can be connected together using fewer bolt inserting holes 34, 35 than the bolt inserting holes 34 formed in the two support frames 13, and the connecting strength can be sufficiently ensured, even if the positions at which the first and second split bodies 27, 28 are connected together are reduced, by making the diameter of the bolt inserting portions 35 formed in the intermediate wall portion 41 larger.

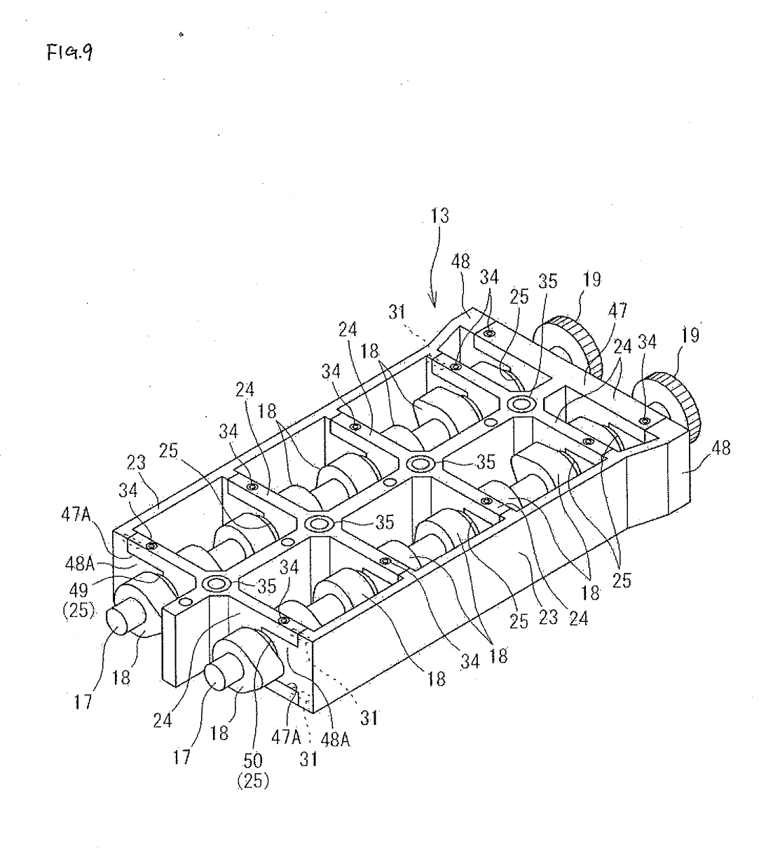

FIG. 9 is a perspective view of a camshaft device 10 according to a fourth example embodiment of the present invention. With the camshaft device 10 of this example embodiment, two camshafts 11 are rotatably supported by a single support frame 13, just as in the third example embodiment. Also, the support frame 13 of this example embodiment is substantially the same, in the basic structure during assembly, as the support frame 13 of the third example embodiment, but the way in which the support frame 13 is split is different. That is, the support frame 13 is split, in the lateral direction, into three portions that are a first split body 47 arranged in a center portion, and two second split bodies 48 arranged on both the left and right sides of this first split body 47, and the first and second split bodies 47, 48 are connected together using bolt inserting holes 34, 35 formed in appropriate locations.

Also, protruding portions 48A that protrude toward the first split body 47-side are formed on the support wall portions 24 of each second split body 48, and second concave portions 50 that form half of the bearing holes 25 are formed on the tip ends of these protruding portions 48A. Also, recess portions 47A are formed on both sides of the support wall portions 24 of the first split body 47, and first concave portions 49 that form the other half of the bearing holes 25 are formed at bottom portions of these recess portions 47A. Also, first and second concave portions 49, 50 are matched up and the bearing holes 25 are formed by inserting the protruding portions 48A into these recess portions 47A.

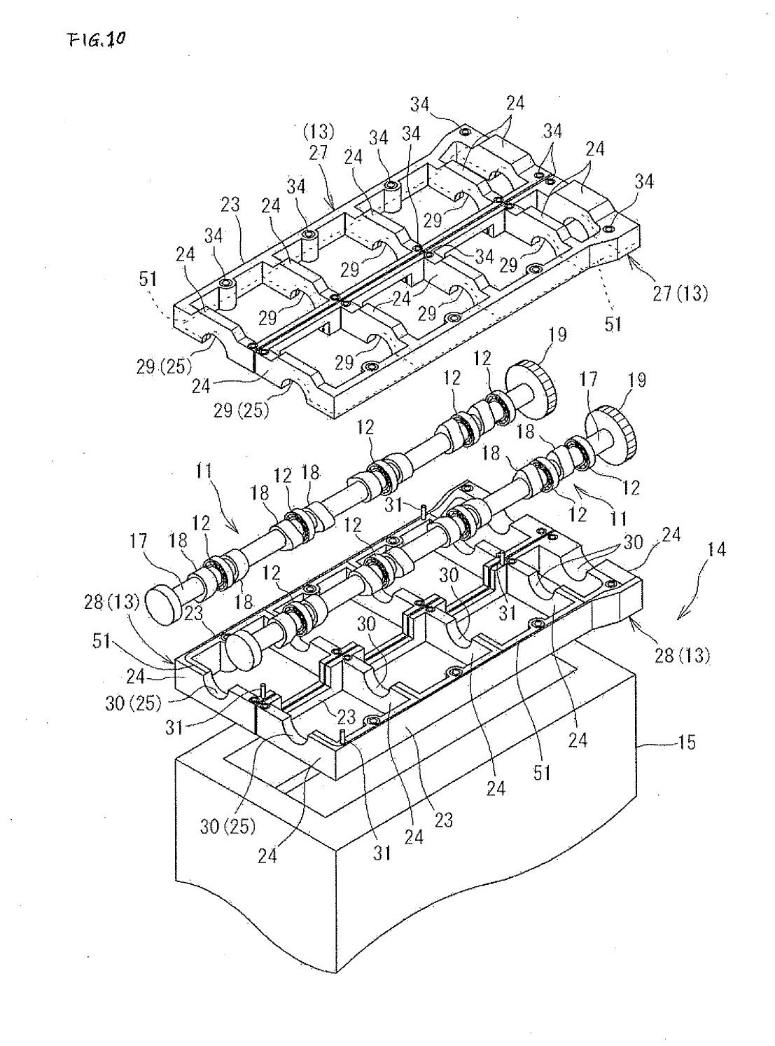

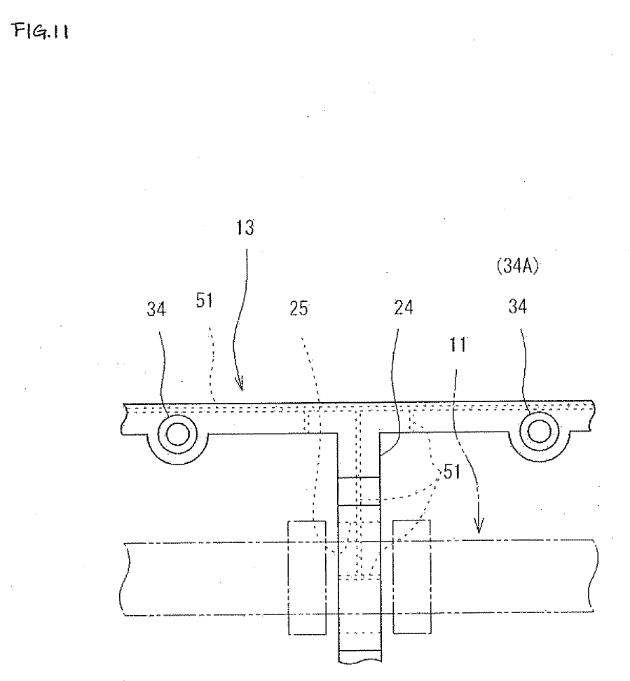

FIG. 10 is an exploded perspective view of a cylinder head and a camshaft device according to a fifth example embodiment of the present invention, and FIG. 11 is a partial plain view of the support frame of the camshaft device. This example embodiment differs from the first example embodiment in that an oil groove 51 for lubricating oil is formed in the mating surfaces of the first and second split bodies 27, 28 of the support frames 13. The other structure is the same as it is in the first example embodiment.

This oil groove 51 extends along the side wall portion 23 from one end portion, in the longitudinal direction, of the first and second split bodies 27, 28, and furthermore branches off toward each bearing hole 25 and cam 18. Therefore, lubricating oil is able to be introduced toward each rolling bearing 12 and each cam 18 and the like by using this oil groove 51. As a result, there is no longer a need to provide a conduit or the like for introducing lubricating oil in the support frames 13, so the structure of the support frames 13 and therearound can be simplified.

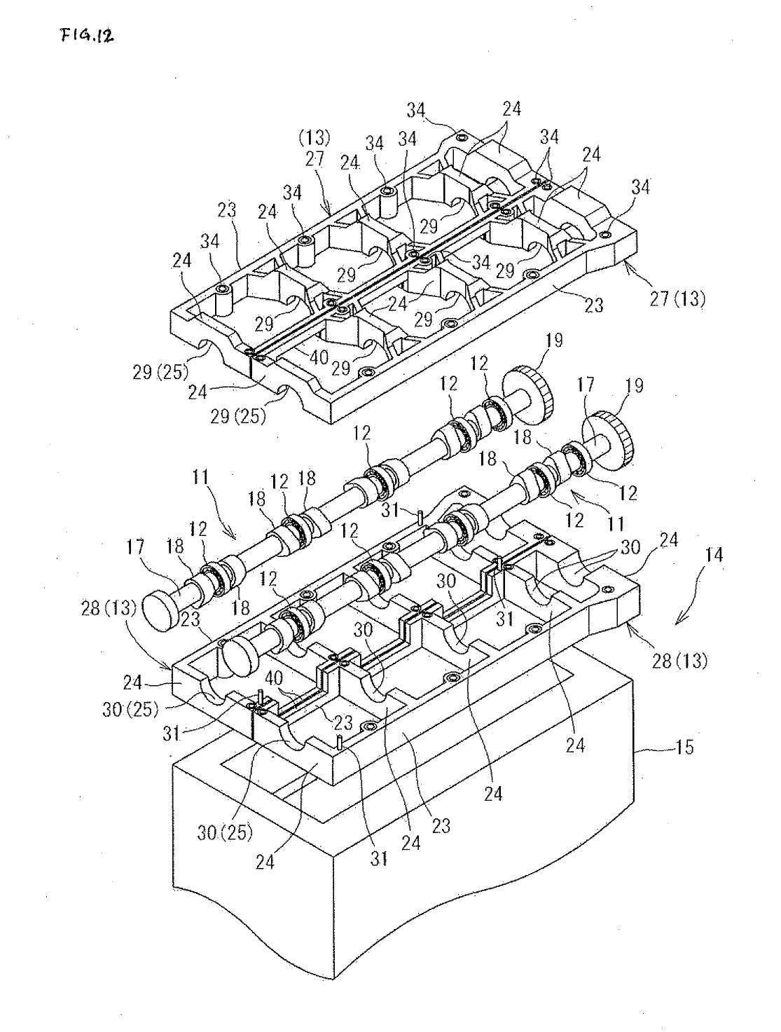

FIG. 12 is an exploded perspective view of a cylinder head and a camshaft device according to a sixth example embodiment of the present invention. In this example embodiment, the support wall portions 24 of the first split body 27 are each formed generally in the shape of the letter X when viewed from above. The other structure is the same as it is in the first example embodiment.

In this example embodiment, just as in the first example embodiment, open portions 40 are formed in the side wall portions 23, and the rigidity of the support frames 13 is reduced by these open portions 40. However, in this example embodiment, the rigidity of the first split body 27 is increased by forming each of the support wall portions 24 of the first split body 27 generally in the shape of the letter X when viewed from above, and a decrease in the rigidity of the support frames 13 that is caused by formation of the open portions 40 is compensated for by the support wall portions 24.

When the rigidity of the first split body 27 is increased in this way, distortion of the first split body 27 caused when this first split body 27 is connected to the second split body 28 is reduced, so the affect on the roundness and coaxiality of the bearing holes 25 can be reduced. Therefore, variation in the accuracy of the internal clearance of the rolling bearings 12 that are fitted into the bearing holes 25 is also reduced, so a small internal clearance (approximately 0 to 15 μm, for example) can be set by taking into account the bending of the camshafts.

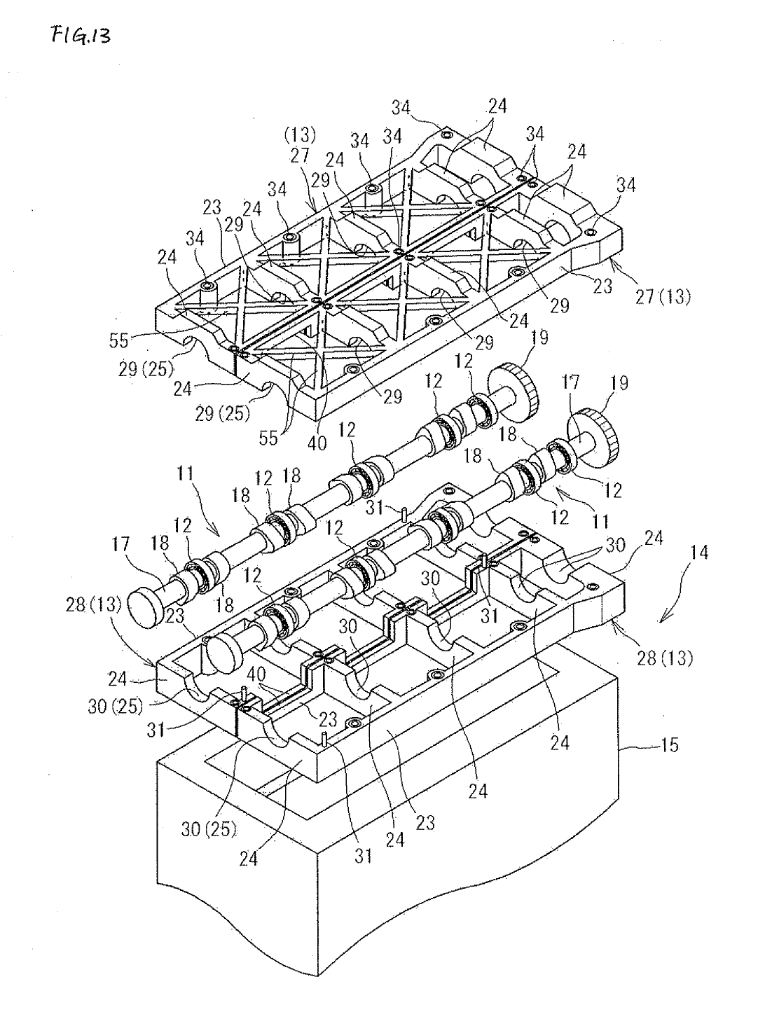

FIG. 13 is an exploded perspective view of a cylinder head and a camshaft device according to a seventh example embodiment of the present invention. This example embodiment differs from the first example embodiment in that generally X-shaped ribs 55 are provided in the square spaces between the side wall portions 23 and support wall portions 24 of the first split body 27. The other structure is the same as it is in the first example embodiment.

Therefore, in this example embodiment as well, the rigidity of the first split body 27 is increased, so the same operation and effects as those of the sixth example embodiment are obtained.

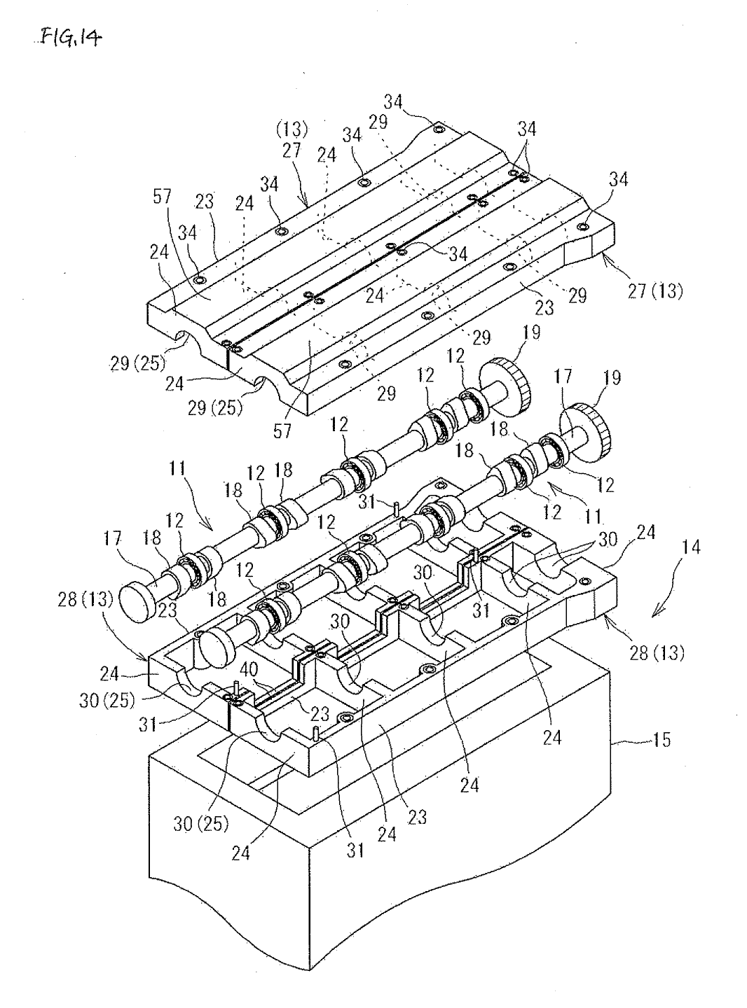

FIG. 14 is an exploded perspective view of a cylinder head and a camshaft device according to an eighth example embodiment of the present invention. This example embodiment differs from the first example embodiment in that a top 57 is provided on an upper surface of the first split body 27, such that the square spaces between the support wall portions 24 and the side wall portions 23 are closed off by the top 57. The other points are the same as they are in the first example embodiment.

Therefore, in this example embodiment as well, the rigidity of the first split body 27 is increased, so the same operation and effects as those of the sixth example embodiment are obtained. Furthermore, the top 57 is able to function as a cylinder head cover.

The present invention is not limited to the foregoing example embodiments. The design may be modified as appropriate. For example, in the example embodiments described above, a DOHC engine provided with two camshafts 11 is given as an example, but the invention may also be applied to a SOHC engine.

A camshaft device of the present invention includes a camshaft onto which a cam is fitted; a plurality of rolling bearings that are fitted at intervals in an axial direction onto this camshaft; and a support frame that is mounted on a cylinder head of an engine, and that has a plurality of bearing holes which are formed on the same axis and into which the rolling bearings fitted, and that rotatably supports the camshaft via the rolling bearings that are fitted into the bearing holes. The support frame is formed by connecting a plurality of split bodies together; and the plurality of split bodies includes a first split body on which a plurality of first concave portions that form half of the bearing holes is integrally formed, and a second split body on which a plurality of second concave portions that form the other half of the bearing holes is integrally formed.

In the support frame of the camshaft device of the present invention, a plurality of first concave portions is integrally formed on a first split body, and a plurality of second concave portions is integrally formed on a second split body. Therefore, when forming a plurality of bearing holes in the support frame, the first split body and the second split body can be fixed in a state where they are fitted together, and the plurality of bearing holes can be simultaneously formed in the first and second split bodies, for example. Also, even if the first and second split bodies are separated after the bearing holes are formed, the positions of the plurality of concave portions formed in the split bodies relative to each other are kept constant. Therefore, regarding the plurality of bearing holes formed by connecting the first and second split bodies together, the coaxiality is increased and variation in the roundness is reduced, so misalignment among the plurality of rolling bearings fitted into the plurality of bearing holes can be reduced. Accordingly, the internal clearance of the rolling bearings can be appropriately maintained, so the running torque of the rolling bearings can be decreased.

The camshaft device described above may include positioning means for positioning the first split body and the second split body such that the first concave portions are aligned with the second concave portions and connecting means for connecting together the first split body and the second split body positioned by the positioning means.

According to this kind of structure, the first and second split bodies can be connected together with the first and second concave portions reliably aligned with each other.

At least one of or all of the plurality of connecting means are preferably arranged in positions that are away in the axial direction from the bearing holes.

In this way, when connecting the first and second split bodies by connecting means arranged in the positions that are away in the axial direction from the bearing holes, the force of connecting the first and second split bodies together by the connecting means can be lessened by the deflection of the support frame by the time it is transmitted to the bearing holes. Therefore, excessive fastening of the outer peripheral surfaces of the rolling bearings by the inner peripheral surfaces of the bearing holes is reduced, so problems such as an increase in the running torque due to a decrease in the internal clearance of the rolling bearings will no longer occur.

More preferably, the connecting means is arranged in an intermediate position between the bearing holes consecutive in the axial direction.

The connecting means preferably includes a bolt, and a bolt inserting hole into which the bolt is inserted is preferably formed in the support frame. In this case, a tubular body that is more rigid than the support frame and that receives at least a portion of fastening power of the bolt is preferably fixed inside this bolt inserting hole.

In recent years, a crankcase, a cylinder block, and a cylinder head and the like of an engine are often made of a light alloy such as aluminum alloy or magnesium alloy in order to make them lighter. Therefore, it is desirable to also make the support frame of the camshaft device out of a light alloy such as aluminum alloy or magnesium alloy. However, these light alloys are less rigid than steel and the like, so distortion tends to easily occur by the fastening power of the bolt. If that distortion spreads to the area around the bearing holes, it may adversely affect the roundness or coaxiality and the like of the bearing holes. Therefore, as in the present invention, distortion of the support frame can be suppressed as much as possible by fixing a tubular body that is more rigid than the support frame inside the bolt inserting holes, such that part or all of the fastening power of the bolt is received by this tubular body. Note that, this invention can also be applied, as a matter of course, to a case in which the support frame or the crankcase and the like of the engine is made of a material other than a light alloy.

The support frame preferably has a pair of side wall portions arranged along an axis of the camshaft with the camshaft interposed therebetween, and a plurality of support wall portions that are extended between this pair of side wall portions, and that are arranged at intervals in the axial direction of the camshaft, and the bearing holes are preferably formed in the support wall portions.

Also, the connecting means for connecting the first and second split bodies together are preferably provided in the side wall portions, and material removed portions that reduce rigidity of the support frame are preferably formed between the connecting means and the bearing holes. The support frame can be made lighter by forming this kind of material removed portion. Also, reducing the rigidity of the support frame between the connecting means and the bearing holes causes the support frame to be deflected more easily at this portion, so the force of connecting the first and second split bodies together by the connecting means is lessened, excessive fastening of the outer peripheral surface of the rolling bearings by the inner peripheral surface of the bearing holes is reduced, and an increase in the running torque due to a decrease in the internal clearance of the rolling bearings 12 is prevented. Also, decreasing the rigidity of the support frame makes it possible to allow slight movement of the rolling bearings, so misalignment among a plurality of rolling bearings can be absorbed.

The support frame may be split into an upper portion and a lower portion, or split into multiple portions in the lateral direction. If the support frame is split into an upper portion and a lower portion, the camshaft device can easily be assembled by placing the camshaft on the lower split body, then placing the upper split body on the lower split body from above, and connecting both split bodies together.

An engine of the present invention is characterized in that the camshaft device described above is connected to an upper surface portion of a cylinder case. Accordingly, an engine in which a load required to rotate the camshaft is reduced can be formed.

A method of the present invention for manufacturing the camshaft device described above is characterized by including a step of temporarily fitting together the positioned first split body and second split body on which the first and second concave portions, respectively, have not been formed; a step of forming the plurality of bearing holes, on the same axis, in the temporarily fitted first split body and second split body; and a step of, after separating the first and second split bodies, repositioning and connecting the first and second split bodies while fitting the rolling bearings that are fitted on the camshaft into the first and second concave portions formed in the first and second split bodies, respectively.

According to this kind of method, the coaxiality among the plurality of bearing holes can be increased, and variation in the roundness can be reduced, such that misalignment among a plurality of rolling bearings that are fitted into the bearing holes can be reduced.

### DESCRIPTION OF THE REFERENCE NUMERALS

10: Camshaft Device 11: Camshaft 12: Rolling Bearing 13: Support Frame 14: Engine 15: Cylinder Head 17: Shaft Main Body 18: Cam 23: Side Wall Portion 24: Support Wall Portion 25: Bearing Hole 27: First Split Body 28: Second Split Body 29: First Concave Portion 30: Second Concave Portion 31: Positioning Pin (Positioning Means) 34: Bolt Inserting Hole 36: Connecting Fitting (Connecting Means) 36A: Bolt 36B: Nut Member 38: Tubular Body 40: Open Portion 41: Intermediate Wall Portion 47: First Split Body 48: Second Split Body

1. A camshaft device comprising:
a camshaft onto which a cam is fitted;
a plurality of rolling bearings that are fitted at intervals in an axial direction onto this camshaft; and
a support frame that is mounted on a cylinder head of an engine, and that has a plurality of bearing holes which are formed on a same axis and into which the rolling bearings are fitted, and that rotatably supports the camshaft via the rolling bearings that are fitted into the bearing holes,
wherein the support frame is formed by connecting a plurality of split bodies together; and
the plurality of split bodies includes a first split body on which a plurality of first concave portions that form half of the bearing holes is integrally formed, and a second split body on which a plurality of second concave portions that form the other half of the bearing holes is integrally formed.

2. The camshaft device according to claim 1, comprising:
positioning means for positioning the first split body and the second split body such that the first concave portions and the second concave portions are aligned with each other; and
a plurality of connecting means for connecting together the first split body and the second split body that are positioned by the positioning means.

3. The camshaft device according to claim 2, wherein at least one or all of the plurality of connecting means are arranged in positions that are away in the axial direction from the bearing holes.

4. The camshaft device according to claim 2, wherein:
the connecting means includes a bolt;
a bolt inserting hole into which the bolt is inserted is formed in the support frame; and
a tubular body that is more rigid than the support frame and that receives at least a portion of fastening power of the bolt is fixed inside this bolt inserting hole.

5. The camshaft device according to claim 1, wherein:
the support frame has a pair of side wall portions arranged along an axis of the camshaft with the camshaft interposed therebetween, and a plurality of support wall portions that are extended between the pair of side wall portions, and that are arranged at intervals in the axial direction of the camshaft; and
the bearing holes are formed in the support wall portions.

6. The camshaft device according to claim 5, wherein:
connecting means for connecting the first and second split bodies together are provided in the side wall portions; and
material removed portions that reduce rigidity of the support frame are formed between the connecting means and the bearing holes.

7. The camshaft device according to claim 1, wherein the support frame is split into upper and lower portions.

8. The camshaft device according to claim 1, wherein the support frame is split into portions in a lateral direction.

9. An engine in which the camshaft device according to claim 1 is connected to an upper surface portion of a cylinder case.

10. A method for manufacturing the camshaft device according to claim 1, comprising:
a step of temporarily fitting together the positioned first split body and second split body on which the first and second concave portions, respectively, have not been formed;
a step of forming the plurality of bearing holes, on a same axis, in the temporarily fitted first split body and second split body; and
a step of, after separating the first and second split bodies, repositioning and connecting the first and second split bodies while fitting the rolling bearings that are fitted on the camshaft into the first and second concave portions formed in the first and second split bodies, respectively.
